(19) United States
(12) Patent Application Publication
(10) Pub. No.: US 2005/0032640 A1
(43) Pub. Date: Feb. 10, 2005

(54) Method and structure for desulfurizing gasoline or diesel fuel for use in a fuel cell power plant

(76) Inventors: He Huang, Glastonbury, CT (US); Zissis A. Dardas, Worcester, MA (US); Roger R. Lesieur, Enfield, CT (US)

Correspondence Address: William W. Jones, 6 Juniper Lane, Madison, CT, 06443, US

(21) Appl. No.: 10/635,268

(22) Filed: Aug. 7, 2003

(51) Int. Cl. B01J 8/04; B01J 35/02

(52) U.S. Cl. 502/337; 422/190; 422/211; 422/222

(57) ABSTRACT

A sulfur scrubbing method and structure is operable to remove substantially all of the sulfur present in an undiluted oxygenated hydrocarbon fuel stock supply which can be used to power an internal combustion engine or a fuel cell power plant in a mobile environment, such as an automobile, bus, truck, boat, or the like, or in a stationary environment. The fuel stock can be gasoline, diesel fuel, or other like fuels which contain relatively high levels of organic sulfur compounds such as mercaptans, sulfides, disulfides, thiophenes, and the like. The undiluted hydrocarbon fuel supply is passed through a desulfurizer bed which is provided with a high surface area nickel reactant, and wherein essentially all of the nickel reactant in the scrubber bed reacts with sulfur in the fuel stream, so as to remove sulfur from the fuel stream by converting it to nickel sulfide on the scrubber bed. The desulfurized organic remnants of the fuel stream continue through the remainder of the fuel processing system in the fuel cell power plant, or through the internal combustion engine. The desulfurizer bed is preferably formed from a high surface area ceramic foam monolith, the pores of which are coated with the high surface area nickel reactant. The use of the foam monolith combined with the high surface area of the reactant, enables essentially 100% of the nickel reactant to come into contact with the fuel stream being desulfurized. The scrubber bed can also be formed from high surface area nickel coated alumina pellets, from a high surface area nickel coated ceramic extrusion, from high surface area nickel pellets, and from high surface area nickel extrudates.

### TECHNICAL FIELD

The present invention relates to a method and structure for desufurizing gasoline, diesel fuel or like hydrocarbon fuel streams so as to render the fuel more suitable for use in a mobil vehicular fuel cell power plant assembly or in an internal combustion engine. More particularly, the desulfurizing method and structure of this invention are operable to reduce the amount of organic sulfur compounds found in these fuels to levels which will not poison the catalysts in the fuel processing section of the fuel cell power plant assembly and will not harm components of an internal combustion engine. The method and structure of this invention comprise a highly porous nickel coated reactant bed which has an extended useful life cycle due to the inclusion of the porous nickel coat. The nickel in the coat is reduced from nickel oxide to nickel after being applied to the scrubber bed support. The reduced nickel removes sulfur from the fuel stream by converting the sulfur to nickel sulfide that deposits on the reactant coated surfaces of the scrubber bed.

### BACKGROUND OF THE INVENTION

Gasoline, diesel fuel, and like hydrocarbon fuels have generally not been used as a process fuel source suitable for conversion to a hydrogen rich stream for small mobile fuel cell power plants due to the existence of relatively high levels of naturally-occurring complex organic sulfur compounds. The presence of sulfur results in a poisoning effect on all of the catalysts used in the hydrogen generation system in a fuel cell power plant. Conventional fuel processing systems used with stationary fuel cell power plants include a thermal steam reformer, such as that described in U.S. Pat. No. 5,516,344. In such a fuel processing system, sulfur is removed by conventional hydrodesulfurization techniques which typically rely on a certain level of recycle as a source of hydrogen for the process. The recycle hydrogen combines with the organic sulfur compounds to form hydrogen sulfide within a catalytic bed. The hydrogen sulfide is then removed using a zinc oxide bed to form zinc sulfide. The general hydrodesulfurization process is disclosed in detail in U.S. Pat. No. 5,292,428. While this system is effective for use in large stationary applications, it does not readily lend itself to mobile transportation applications because of system size, cost and complexity. Additionally, the fuel gas stream being treated must use large quantities of process recycle in order to provide hydrogen in the gas stream, as noted above.

Other fuel processing systems, such as conventional autothermal reformers, which use a higher operating temperature than conventional thermal steam reformers, can produce a hydrogen-rich gas in the presence of the aforesaid complex organic sulfur compounds without prior desulfurization. When using an autothermal reformer to process raw fuels which contain complex organic sulfur compounds, the result is a loss of autothermal reformer catalyst effectiveness and the requirement of reformer temperatures that are 200° F.-500° F. (93° C.-26° C.) higher than are required with a fuel having less than 0.05 ppm sulfur. Additionally, a decrease in useful catalyst life of the remainder of the fuel processing system occurs with the higher sulfur content fuels. The organic sulfur compounds are converted to hydrogen sulfide as part of the reforming process. The hydrogen sulfide can then be removed using a solid absorbent scrubber, such as an iron or zinc oxide bed to form iron or zinc sulfide. The aforesaid solid scrubber systems are limited, due to thermodynamic considerations, as to their ability to lower sulfur concentrations to non-catalyst degrading levels in the fuel processing components which are located downstream of the reformer, such as in the shift converter, or the like.

Alternatively, the hydrogen sulfide can be removed from the gas stream by passing the gas stream through a liquid scrubber, such as sodium hydroxide, potassium hydroxide, or amines. Liquid scrubbers are large and heavy, and are therefore useful principally only in stationary fuel cell power plants. From the aforesaid, it is apparent that current methods for dealing with the presence of complex organic sulfur compounds in a raw fuel stream for use in a fuel cell power plant require increasing fuel processing system complexity, volume and weight, and are therefore not suitable for use in mobile transportation systems.

An article published in connection with the 21st Annual Power Sources Conference proceedings of May 16-18, 1967, pages 21-26, entitled “Sulfur Removal for Hydrocarbon-Air Systems”, and authored by H. J. Setzer et al, relates to the use of fuel cell power plants for a wide variety of military applications. The article describes the use of high nickel content hydrogenation nickel reactant to remove sulfur from a military fuel called JP-4, which is a jet engine fuel, and is similar to kerosene, so as to render the fuel useful as a hydrogen source for a fuel cell power plant. The systems described in the article operate at relatively high temperatures in the range of 600° F. (320° C.) to 700° F. (380° C.). The article also indicates that the system tested was unable to desulfurize the raw fuel alone, without the addition of large quantities of water or hydrogen, due to reactor carbon plugging. The carbon plugging occurred because the tendency for carbon formation greatly increases in the temperature range between about 550° F. (290° C.) and about 750° F. (460° C.). A system operating in the 600° F. to 700° F. range would be very susceptible to carbon plugging, as was found to be the case in the system described in the article. The addition of either hydrogen or steam reduces the carbon formation tendency by supporting the formation of gaseous carbon compounds thereby limiting carbon deposits which cause the plugging problem.

It would be highly desirable from an environmental standpoint to be able to power electrically driven vehicles, such as an automobile, for example, by means of fuel cell-generated electricity; and to be able to use a fuel such as gasoline, diesel fuel, naphtha, lighter hydrocarbon fuels such as butane, propane, natural gas, or like fuel stocks, as the fuel consumed by the vehicular fuel cell power plant in the production of electricity. In order to provide such a vehicular power source, the amount of sulfur in the processed fuel gas would have to be reduced to and maintained at less than about 0.05 parts per million.

The desulfurized processed fuel stream can be used to power a fuel cell power plant in a mobile environment. The fuel being processed can be gasoline or diesel fuel, or some other fuel which contains relatively high levels of organic sulfur compounds such as thiophenes, mercaptans, sulfides, disulfides, and the like. The fuel stream is passed through a nickel desulfurizer bed wherein essentially all of the sulfur in the organic sulfur compounds reacts with the nickel reactant and is converted to nickel sulfide leaving a desulfurized hydrocarbon fuel stream which continues through the remainder of the fuel processing system. U.S. Pat. No. 6,129,835, granted Oct. 10, 2000; and U.S. Pat. No. 6,156,084, granted Dec. 5, 2000 describe systems for use in desulfurizing a gasoline or diesel fuel stream for use in an internal combustion engine; and a mobile fuel cell vehicular power plant, respectively. The desulfurization beds in the aforesaid systems, both fixed and mobile, would typically utilize alumina pellets which have been admixed with the nickel reactant prior to being formed. Thus the alumina powder and nickel powder are mixed together and the pellets are then formed from the mixture. Using this procedure, a major portion of the nickel reactant ends up in the interior of the pellets, and is unable to contact the fuel stream being desufurized, and thus is wasted. The use of pelletized desulfurization beds using a nickel reactant is thus inefficient to a certain extent.

U.S. Pat. No. 6,140,266, granted Oct. 31, 2000 describes a compact and light weight catalyst bed which is designed for use with a fuel cell power plant which catalyst bed is useful in a fuel cell power plant reformer assembly. The content of this patent is incorporated into this application in its entirety. The foam support provides a very high surface area bed with excellent flow through characteristics. The use of such an open cell foam support would provide a fuel desulfurizing bed that would ensure that essentially 100% of the nickel reactant would be exposed to the fuel stream being desulfurized. Thus, the use of an open cell foam support member in a nickel-based reactant desulfurizing bed would greatly increase the efficiency of the desulfurizer and also increase its useful life.

We have discovered a way to further increase the useful life of a sulfur scrubber bed and sulfur scrubbing method, by further increasing the surface area of the reactant, irrespective of the reactant support structures utilized in the scrubber bed. Our improvement involves the use of a highly porous nickel oxide reactant coating which is applied to all exposed surfaces in the scrubber bed and thereafter reduced to nickel. The use of the highly porous nickel reactant coating increases the useful life of sulfur scrubber beds using alumina or silica pellets as the reactant support, or using an open cell porous foam as the reactant support, or using a honeycomb-type monolith structure as the reactant support.

### DISCLOSURE OF THE INVENTION

This invention relates to an improved desulfurizing bed structure and method for processing a gasoline, diesel, or other hydrocarbon fuel stream over an extended period of time, so as to remove substantially all of the sulfur present in the fuel stream, which structure and method provide a longer sulfur removal useful life. The bed structure and method of this invention include a support member onto which a highly porous nickel oxide material is deposited. The nickel oxide coating is highly porous, i.e., it has randomly distributed micro pores on its surface and has a very high surface area. After the nickel oxide is reduced to nickel, the micro pores will vary in size from one micron to fifty microns in diameter. With the support micro porosity, the reduced nickel reactant coat will result in a nickel surface area of over fifty square meters per gram (M²/gm) of reactant in the scrubber bed structure. This micro porosity and increase surface area greatly increase the amount of nickel in the scrubber bed which is available and able to react with sulfur in the fuel stream so as to remove the sulfur from the fuel stream and convert it to nickel sulfide on the scrubber bed surface. When all of the available nickel sites on the scrubber bed surface have been converted to nickel sulfide, then the scrubber bed will be deemed to have reached a “sulfur breakthrough” condition and will be unable to convert further sulfur in the fuel stream to produce the desired low sulfur content fuel. By using the highly porous nickel coating in lieu of a standard nickel coating, the useful life of the scrubber bed is extended by a factor of about five.

Gasoline is a hydrocarbon mixture of paraffins, naphthenes, olefins and aromatics, whose olefinic content is between 1% and 15%, and aromatics between 20% and 40%, with total sulfur in the range of about 20 ppm to about 1,000 ppm. The national average for gasoline in the United States is 350 ppm sulfur. The legally mandated average for the State of California for gasoline is 30 ppm sulfur. As noted above, the sulfur content of gasoline must be less than about 0.05 ppm to be useful in a fuel cell power plant as a source of hydrogen. This low level is also beneficial in that it minimizes internal combustion engine damage from sulfur.

The effectiveness of a nickel adsorbent reactant to adsorb organic sulfur compounds from gasoline depends on the relative coverage of the active reactant sites by adsorption of all the various constituents of gasoline. In other words, the desulfurization process depends on the amount of competitive adsorption of the various constituents of gasoline. From the adsorption theory, it is known that the relative amount of adsorbate on an adsorbent surface depends primarily on the adsorption strength produced by attractive forces between the adsorbate and adsorbent molecules and secondarily on the concentration of the adsorbate in the gasoline, and temperature. Coverage of a reactant surface by an adsorbate increases with increasing attractive forces; higher fuel concentration; and lower temperatures. Relative to gasoline, Somorjai (Introduction to Surface Chemistry and Catalysis, pp, 60-74) provides some relevant information on the adsorption of hydrocarbons on transition metal surfaces, such as nickel. Saturated hydrocarbons only physically adsorb onto the nickel reactant surface at temperatures which are less than 100° F. (40° C.), therefore paraffins, and most likely naphthenes, won't compete with sulfur compounds for adsorption sites on the nickel reactant at temperatures above 250° F. (121° C.) and 300° F. (149° C.).

On the other hand, unsaturated hydrocarbons, such as aromatics and olefins, adsorb largely irreversibly on transition metal surfaces even at room temperature. When an unsaturated hydrocarbon such as an aromatic or an olefin adsorbs on a transition metal surface, and the surface is heated, the adsorbed molecule rather than desorbing intact, decomposes to evolve hydrogen, leaving the surface covered by the partially dehydrogenated fragment, i.,e., tar or coke precursors. At 350° F. (177° C.), unsaturated hydrocarbons are nearly completely dehydrogenated, and the dehydrogenated tar fragments form multiple carbon atom-to-nickel reactant surface bonds. This explains why aromatics and olefins in gasoline, in the absence of oxygenated compounds in appropriate concentrations, will deactivate the nickel reactant from adsorbing sulfur after a relatively short period of time. To prevent this from occurring, it is preferred to use gasoline which contains an oxygenate, such as ethanol, methanol, MTBE, or the like, in order to generate a small amount of hydrogen to prevent dehydrogenation of aromatics and olefins in the gasoline.

Further nonessential but enabling information relating to this invention will become readily apparent to one skilled in the art from the following detailed description of a preferred embodiment of the invention when taken in conjunction with the accompanying drawings in which:

### BRIEF DESCRIPTION OF THE DRAWINGS

These and other objects and advantages of this invention will become readily apparent to one skilled in the art from the following detailed description of a preferred embodiment of the invention when taken in conjunction with the accompanying drawings in which:

FIG. 1 is a perspective view of one form of an open cell foam monolith sulfur scrubber bed formed in accordance with this invention;

FIG. 2 is a fragmented perspective view of a heat transfer component and foam sulfur scrubber bed assembly which are bonded together;

FIG. 3 is a perspective view of a sheet metal monolith sulfur scrubber bed formed in accordance with this invention;

FIG. 4 is an end elevational view of the scrubber bed of FIG. 3;

FIG. 5 is a fragmented perspective view of an extruded ceramic monolith sulfur scrubber bed formed in accordance with this invention; and

FIG. 6 is a graph comparing the performance of sulfur scrubber beds formed in accordance with this invention with conventional sulfur scrubber beds formed in accordance with the prior art.

### SPECIFIC MODE FOR CARRYING OUT THE INVENTION

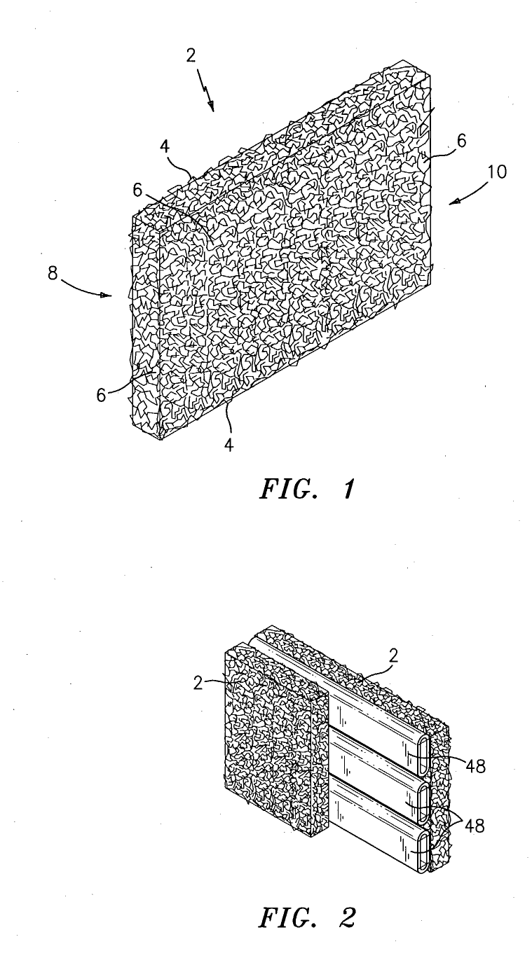

Referring now to the drawings, there is shown in FIG. 1 a perspective view of a rectilinear form of a sulfur scrubber bed formed in accordance with this invention, which bed is denoted generally by the numeral 2. The scrubber bed 2 is a monolithic open cell foam support component which includes a lattice network of tendrils 4 that form a network of open cells 6 which are interconnected in the X, Y and Z directions within the bed 2. The interconnected open cells 6 are operable to form an enhanced fuel gas mixing and distribution flow path from end 8 to end 10 of the bed 2. The open cells 6 and the tendrils 4 also provide a very large nickel reactant-available surface area for coating in the bed 2. The core or support member of the foam scrubber bed 2 can be formed from aluminum, stainless steel, an aluminum-steel alloy, silicon carbide, nickel alloys, carbon, graphite, a ceramic, or the like material. One preferred material is cordierite, which is a porous ceramic alumina/silica mineral.

Typically, the bed 2 is coated with the highly porous nickel oxide surface layer in the following manner. A coat of the highly porous nickel oxide and an acid, such as acetic acid, nitric acid, or the like, is applied to all outer and interstitial surfaces in the foam core 2. The washcoat can be applied to the core 2 by dipping the core 2 into a washcoat solution, or by spraying the washcoat solution onto the core 2. The washcoated core 2 is then calcined so as to form the solidified highly porous nickel oxide layer on all surfaces of the core 2. The highly porous nickel oxide wash coat is preferably one produced by Sud-Chemie, Inc. by co-precipitating a highly dispersed nickel with non-reducible oxides, such as alumina, silica, rare earth oxides, or the like. The inclusion of the non-reducible oxides provides the enhanced surface area for the nickel reactant, and prevents sintering of the nickel surface, which would reduce the surface area thereof. The co-precipitation of nickel and the oxides forms the washcoat, and then the washcoat is applied to the support.

FIG. 2 is a fragmented perspective view showing separate members of the nickel reactant coated foam components 2 which are bonded to heat transfer components 48. By bonding the open cell foam components 2 to an adjacent heat transfer components 48, which can be planar walls, or coolant conduits, continuation of the high thermal conductivity of the foam 2 into the heat transfer component 48 is achieved. The heat transfer components 48 can made of aluminum, stainless steel, steel-based alloys containing aluminum, or high nickel alloys, as dictated by requirements of the system into which the components 2, 48 are incorporated.

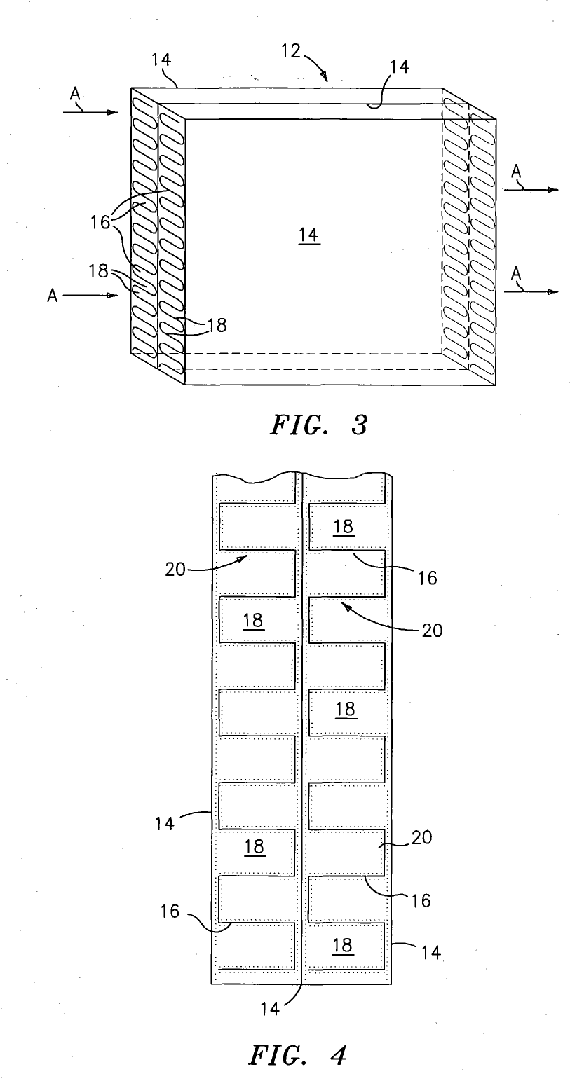

Referring now to FIG. 3, there is shown a monolithic form of a sulfur scrubber bed which is denoted generally by the numeral 12. The scrubber bed 12 is formed from sheet metal components that can be coated with the highly porous reducible nickel oxide layer described herein. The bed 12 can be formed from a series of planar components 14 which are spaced apart and are separated by honey comb components 16 which are also formed from a washcoatable sheet metal. The components 16 and the planar components 14 combine to form through passages 18 which have their surfaces coated as indicated by the numeral 20 in FIG. 4. The fuel stream being desulfurized flows through the passages 18 in the direction indicated by the arrows A.

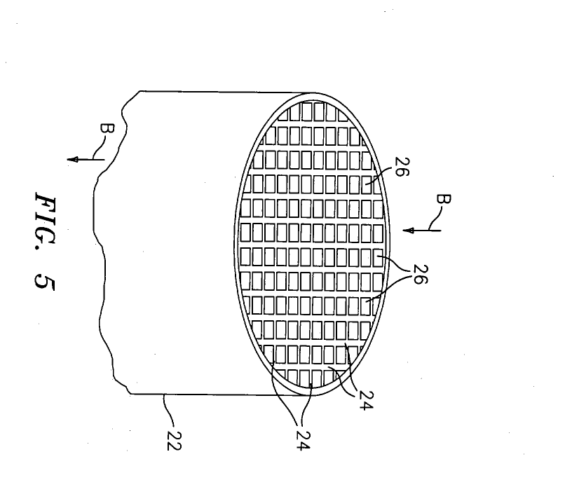

Referring now to FIG. 5, there is shown yet another embodiment of a sulfur scrubber module which is formed in accordance with this invention. The desulfurizer module shown is formed from an extruded ceramic monolith which is denoted generally by the numeral 22. The monolith is preferably formed from cordierite, which is an alumina-silica mineral which can be artificially manufactured. The monolith 22 includes a plurality of crisscrossing webs 24 which form through passages 26 that extend through the monolith 22. All of the exposed surfaces on the monolith 22 are coated with the reducible porous nickel oxide material. The fuel being desulfurized passes through the monolith 22 in the direction of the arrows B. The sulfur scrubber can be formed for a single monolith 22 or by a bundled plurality of the monoliths 22.

In addition to the above-identified monolith reactant support members, we have also discovered that the porous reducible nickel oxide material described herein will increase the useful life of a sulfur scrubber station which uses packed pellets as the reactant support. The pellets will typically be formed from alumina powder which is compressed into pellet form. The surface of the formed pellets is then coated with the reducible nickel oxide material which is then reduced to form the highly porous nickel reactant. This method of coating the support pellets greatly enhances the surface area of the reactant on the pellets and does not result in unusable reactant, which can result when the pellets are formed from a mixture of alumina powder and nickel powder, wherein some of the nickel will be encapsulated inside of the pellets and thus be rendered unusable in the desulfurizing reaction.

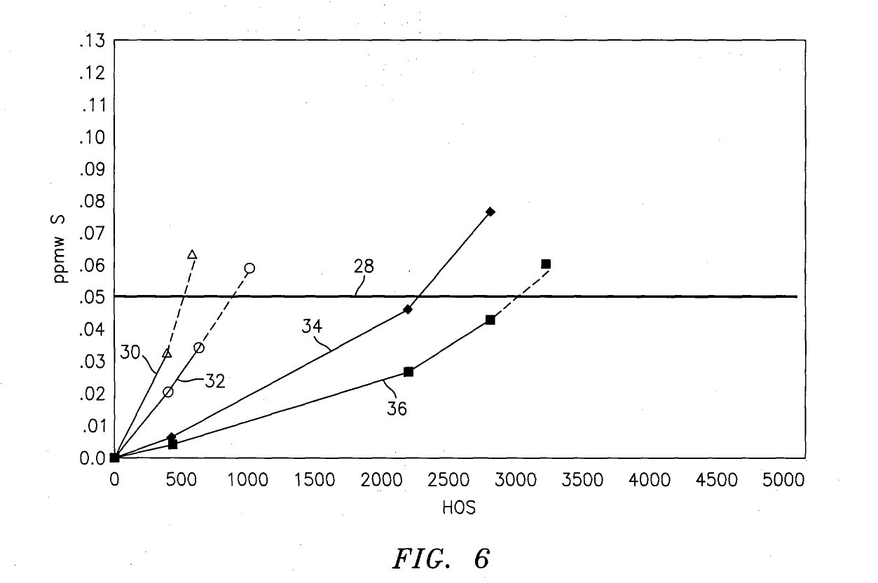

Referring now to FIG. 6, there is shown a graph which illustrates the improved performance of nickel based sulfur scrubber beds that are formed in accordance with this invention as compared with nickel based sulfur scrubber beds formed in accordance with the prior art. The prior art scrubber beds used in the comparison shown in FIG. 6 were formed from alumina pellets that incorporated nickel powder as the sulfur adsorbent.

The Y axis of the graph indicates the concentration of sulfur in the fuel stream being processed as measured by a sulfur sensor incorporated into the scrubber bed. The X axis of the graph shows the hours of service for the scrubber bed.

The scrubber beds formed in accordance with this invention were made from alumina pellets that were coated with two different but related coats of the enhanced surface area nickel oxide that were both reduced to a nickel reactant. The graph illustrates a sulfur breakthrough level of 0.05 ppm sulfur, shown as line 28. This breakthrough level is the concentration of sulfur in the fuel stream which is the uppermost sulfur concentration that a fuel cell fuel processing assembly can tolerate. When the sulfur scrubber bed becomes incapable of producing a fuel gas stream having less than 0.05 ppm sulfur in it, the scrubber bed will be considered to be inoperable or spent.

As noted above, the scrubber beds that were formed in accordance with the prior art used a lower surface area, i.e., less than fifty M²/gm surface area, nickel sulfur adsorbent incorporated into alumina pellets. The plots of sulfur concentration v. time for the prior art sulfur scrubber beds are indicated by the lines 30 and 32. It will be noted that sulfur breakthrough occurred at approximately five hundred hours of bed operation; and at approximately seven hundred hours as indicated by the plots 30 and 32 of the two prior art sulfur scrubber beds tested.

The performance plots of the two versions of sulfur scrubber beds that were formed in accordance with this invention are denoted by the lines 34 and 36. It will be noted that sulfur breakthrough occurred at approximately twenty four hundred hours and approximately three thousand hours as indicated by the plots 34 and 36 of the two sulfur scrubber beds tested that were formed in accordance with this invention.

It will be noted that the sulfur scrubber beds formed in accordance with the invention that are depicted in FIG. 6 were formed with pelletized support members for the nickel reactant, and still produced marked improvement in performance as compared to the prior art which also utilized pelletized support members for the nickel reactant.

When sulfur scrubber bed supports are formed from the foams and extruded monoliths described above, and are used to support the high surface area nickel reactant, the improvements in hours of service will be even greater than shown in FIG. 6, because the surface area of the foam and monolith supports which is washcoated with the reduced nickel reactant is volumetrically much greater than the surface area of a volume of packed alumina pellets which are washcoated with the nickel reactant.

Monolith open cell foam cores of the type described above can be obtained from ERG Energy Research and Generation, Inc. of Oakland, Calif. which cores are sold under the registered trademark “DUOCEL”. Another source of the foam cores is Porvair, Inc., of Ashville, N.C.

A high surface area reducible nickel oxide coat material of the type described herein above can be obtained from Sud-Chemie, Inc. of Louisville, Ky. The nickel oxide material available from Sud-Chemie is identified by Sud-Chemie's product designations T-2496 and T-2694A. The nickel oxide coat material is the most preferred form of the nickel reactant due to longer term stability. Alternatively, the nickel oxide material could be extruded to form a high surface area support per se without requiring a separate nickel oxide coating. Thus, the nickel oxide material could be used as a coating on a support material, or it can be used as a reactant without a separate support material. The nickel oxide is reduced to nickel prior to use.

Since many changes and variations of the disclosed embodiments of the invention may be made without departing from the inventive concept, it is not intended to limit the invention other than as required by the appended claims.

1. A sulfur scrubber assembly for removing sulfur from a gasoline or diesel fuel stream so as to reduce the concentration of sulfur in the fuel stream to less than about 0.05 ppm, said assembly comprising:
a) a support structure; and
b) a nickel reactant deposited on said support structure, said nickel reactant being operative to react with sulfur in the fuel stream so as to remove sulfur from the fuel stream and form nickel sulfide deposits on the support structure, said nickel reactant having surface area which is greater than about fifty square meters per gram of nickel reactant.

2. The assembly of claim 1 wherein said nickel reactant is the result of reducing a nickel oxide coating deposited on said support structure.

3. The assembly of claim 2 wherein the nickel oxide coating is produced by co-precipitation of finely divided nickel and a non-reducible oxide.

4. The assembly of claim 3 wherein the non-reducible oxide is alumina.

5. The assembly of claim 3 wherein the non-reducible oxide is an oxide selected from the group consisting of silica, alumina, and rare earth oxides.

6. The assembly of claim 1 wherein said support structure is a pellet bed.

7. The assembly of claim 1 wherein said support structure is a porous foam body.

8. The assembly of claim 1 wherein said support structure is an extruded ceramic monolith.

9. A sulfur scrubber assembly for removing sulfur from a gasoline or diesel fuel stream so as to reduce the concentration of sulfur in the fuel stream to less than about 0.05 ppm, said assembly including an extruded nickel reactant having a surface area which is greater than about fifty square meters per gram of nickel reactant.

10. The assembly of claim 9 wherein said nickel reactant is the result of reducing a nickel oxide precursor.

11. A method for producing a sulfur scrubbing assembly that is operative to remove sulfur from a gasoline or diesel fuel stream, said method comprising the steps of:
a) providing a support structure for the assembly;
b) providing said support structure with a coating that includes nickel oxide and that has a surface area of greater than about fifty square meters per gram of said coating; and
c) reducing said nickel oxide in said coating to nickel.

12. The method of claim 11 wherein said support structure is porous.

13. The method of claim 12 wherein said porous support structure is a foam.

14. The method of claim 12 wherein said porous support structure is an extruded ceramic monolith.

15. The method of claim 11 wherein said coating is a co-precipitated mixture of nickel and one or more high surface area non-reducible oxide.

16. A method for removing sulfur from a gasoline or diesel fuel stream, said method comprising the steps of:
a) providing a sulfur scrubber assembly having a nickel reactant layer with a surface area that is greater than about fifty square meters per gram of reactant; and
b) passing said fuel stream through said scrubber assembly in a manner which will enable the nickel reactant to react with sulfur in the fuel stream and reduce the concentration of sulfur in the fuel stream to less than about 0.05 ppm.
